(19) United States
(12) Patent Application Publication
(10) Pub. No.: US 2022/0292034 A1
(43) Pub. Date: Sep. 15, 2022

(54) BUS SYSTEM WITH ADDRESSABLE UNITS AND METHOD FOR ADDRESSING SAID UNITS

(71) Applicant: ebm-papst Mulfingen GmbH & Co. KG, Mulfingen (DE)

(72) Inventors: Markus Humm, Weißbach (DE); Andreas Fessel, Weikersheim (DE)

(21) Appl. No.: 17/687,878

(22) Filed: Mar. 7, 2022

(30) Foreign Application Priority Data
Mar. 11, 2021 (DE) 10 2021 105 919.4

(51) Int. Cl. G06F 13/362; G06F 13/42; G06F 13/12

(52) U.S. Cl. CPC G06F 13/362; G06F 13/4221; G06F 13/122

(57) ABSTRACT

A master-slave system with n slave units serially connected via a bus line, each slave unit having a control input for receiving an input signal from the output of the preceding slave unit in the series and a control output for sending an output signal to the following slave unit in the series; wherein the control input of the first slave unit is not signaled; each slave unit having an address memory, designed to store a collective broadcast address and/or an individual unit address; and wherein a control line is provided between two serially successive slave units, which respectively connects the control output of the preceding slave unit in the series to the control input of the following slave unit, in such a manner that the output signal at the control output is at the same time the input signal at the control input of the following slave unit.

### CROSS REFERENCE TO RELATED APPLICATIONS

This application claims the benefit of priority under 35 U.S.C. § 119 to German Patent Application No.: 10 2021 105 919.4, filed Mar. 11, 2021, the contents of which is incorporated herein by reference in its entirety.

### FIELD

The invention relates to a bus system with addressable units and a method of addressing said units. More specifically, the bus system is an addressable master-slave bus system wherein the method describes a way of addressing the slave units.

### BACKGROUND

The statements in this section merely provide background information related to the present disclosure and several definitions for terms used in the present disclosure and may not constitute prior art.

In the prior art, various bus systems with their components and methods for addressing the components have been known for a very long time. Here, in principle, in master-slave based bus systems, there is a master unit and at least one slave unit but preferably a plurality of slave units, which can be addressed, that is to say controlled, by the master unit. Here, the commands or messages of the master unit are transmitted via an at least half-duplex capable bus system and a bus line of this bus system, wherein the commands of the master unit are transmitted with an address of the slave unit to be controlled to all the slave units of the system. Although all the slave units receive or “hear” the commands, only the slave unit which itself has the address transmitted with the command accepts or executes the command.

Depending on the bus system, the bus line can be provided with connecting plugs and be led from the master unit to a first slave unit and in series from slave unit to slave unit. Alternatively, a looping through the slave units is also possible, in which in each case a bus line thus leads from the master unit to the first slave unit and then from slave unit to slave unit, which likewise results in a series connection of the slave units or a bus topology.

Since a command is transmitted via the bus line from the master unit to all the slave units, all the slave units “hear” or receive the command, but only the actually actuated slave unit is supposed to react. From this it results that the addresses of all the slave units to be controlled must be known by the master unit and each slave unit must possess an individual address which is unique within the bus system.

In order to assign such an address, manual, semiautomatic or also automatic methods are used in the prior art, which are based, for example, on the fact that the addresses of the slave units are incrementally increased in an order established by their connection to one another, until the last slave unit of the series has been addressed.

However, this has the disadvantage that the addresses which are allocated are predetermined and subject to a fixed pattern. Here, it is not possible to assign “arbitrary” addresses which deviate from the predetermined fixed pattern to the slave units.

Address allocation variants also exist, in which an address for the slave units is written in a memory by a parametrization manually carried out on each slave unit, process which must then be repeated for each slave unit and wherein the addresses in addition also have to be communicated to the master unit, which results in a high cost.

In addition, also known are solutions which are based on a control line leading from slave unit to slave unit, which controls the slave units during an addressing, wherein it is often provided here that the control line or a signal transmitted via the control line is looped through in the slave units, for example, controlled via a switch. However, such a design has the disadvantage that all the slave units necessarily have to be connected by means of the control line, which can be problematic in the case of slave units which are at a distance from one another, and that usually complex commands or complex signal sequences have to be transmitted via the control line or the associated bus system in order to control an addressing, so that such methods overall are subject to high complexity.

DE 103 36 301 A1 proposes an automated addressing process. The addressing process is likewise provided for a master-slave bus system with a bus line, the start and end of which are connected to the master unit. In this method, during the course of an address allocation process, the bus line of the system is interrupted, so that the master unit must address the slave unit via a clock input. Moreover, the method can only be used for systems which have a ring-shaped bus line. The present method describes such an addressing method.

From EP 2 287 689 EP, an additional bus-based addressing method for slave units is known. For this purpose, the slave units in each case must have bus interfaces which are suitable for the bus system used, via which they are connected to one or more bus lines of a master-slave bus system.

### SUMMARY

The objective of the present disclosure is to remedy the aforementioned disadvantages and to provide an improved bus-based method for addressing slave units as well as a corresponding addressable master-slave system which relies on a bus architecture for the address allocation and which is simple and reliable in terms of implementation, handling and during operation.

This objective is achieved with a master-slave system comprising a master unit with n slave units which are serially connected via a bus line, each slave unit having a control input for receiving an input-side signal from the output of the preceding slave unit in the series and a control output for sending an output-side signal to the respective following slave unit in the series of the n slave units; wherein the control input of the first slave unit is not signaled; each slave unit having an address memory, which is designed to store a collective broadcast address and/or an individual unit address. A control line is provided between two serially successive slave units, which respectively connects the control output of the preceding slave unit in the series to the control input of the following slave unit, in such a manner that the output signal at the control output is at the same time the input signal at the control input of the respective following slave unit.

The objective is further achieved by a bus-based method for addressing n slave units of the master-slave bus system that includes the following steps:

a) setting of a common start address at all the n slave units, preferably by broadcast command(s) or by factory setting, so that all the slave units have the same start address;

b) successive sending of broadcast commands from the master unit to all the slave units to activate the output signal of the control output at the respective control output of the slave unit in question;

c) sending of readdressing commands to the slave units with common start address with the goal of changing the address of the respective slave unit which has no signal applied at its control input or which has no signaled state;

d) sending of a command to the respective newly allocated slave unit address to “deactivate” the signal at the control output at the slave unit in question, so that, in the next successively following slave unit in the chain, a signal is no longer applied at its control input; and

e) successive repeating of steps c) and d) until all the slave units are readdressed and, in particular, until acknowledgment of the command for the address change of the slave units with the originally allocated initial address no longer occurs.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawing, in which:

FIG. 1 is a schematic representation of a master-slave bus system according to the teachings of the present disclosure.

The drawing is provided herewith for purely illustrative purposes and is not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The solution according to the present disclosure enables an allocation of unique addresses in cabling order. Nevertheless, the addresses can be allocated flexibly within an address space, since, in contrast to the shift register method, the addresses do not have to be allocated in an ascending or descending manner.

Furthermore, an advantage with respect to the serial number auto-addressing (as known, for example, from EP 2503763 B1) consists in that the order of finding of the slave units occurs strictly in cabling order and, as a result, the position of the slave unit according to the cable plan is exactly known.

An additional advantage with respect to known addressing methods is that no enable circuit with relays and switches, which makes a selection between two enable signals, is necessary. The method according to one aspect of the present disclosure gets by with only one control line for the enabling. In the circuit topology according to the present disclosure, for forwarding the control signals from one slave unit to the next, no switch is required. Input and output signals are thus completely separate from one another.

The basic idea of the present disclosure includes the following concept. In master-slave based bus systems, there is a master unit and there are n slave units to be addressed. Said slave units are all interconnected by means of a half-duplex capable bus system via a bus line. Here, in each slave unit, the bus is looped through to the next slave unit, which has the effect that all the bus signals of all the subscribers in each case also are simultaneously applied to all the other subscribers connected to the bus system.

According another aspect of the present disclosure, each slave unit moreover has at least one control input DCI-in (digital or analog input) as well as at least one control output DCI-out (digital or analog output) for the addressing. The output of the first (initial) slave unit is connected to the input of the second slave unit, the output of the second is connected to the third, etc., and the output of the last slave unit can optionally be connected to an input of the master unit in order to notify the master unit of the end of the addressing process.

At the beginning of the addressing process according to the teachings of the present disclosure, all the slave units have the same address, for example, the address “1.” However, this is dependent on the selected bus system and the address space. If a MODBUS-RTU is used, the address space ranges from 1 to 247, wherein the address “0” is used as broadcast address for all the slave units.

However, broadcasts in known bus systems do not lead to any responses on the part of the slave units back to the master unit. The establishment of such an initial position can occur by bus commands to the MODBUS-RTU broadcast address 0 to change the slave unit address to 1. However, this is not necessary if all the slave units are delivered already provided at the factory with the address 1.

After the method according to the invention has been carried out, each slave unit has a slave unit address uniquely allocated in the bus system, so that a communication request from master unit is processed and answered by only one slave unit. The address assignment is necessary so that it is possible to communicate on the bus. According to the invention, this addressing is accomplished automatically. The DCI-in of the first slave unit is not connected. Via a broadcast command to the address 1, all the slave units are first caused to output a signal at their respective DCI-out. This signal can be, for example, positive or negative, that is to say also a bridging to ground potential. In principle, the concept according to the invention provides that only the slave units which have the addressed address and at the input DCI-in of which no signal is applied react to a command.

All the subscribers of the bus system which still have the initial address 1 and have a signal applied to their DCI-in do not react to commands to this initial address. As a matter of principle, the first subscriber of the chain does not have a signal at its DCI-in, since the input is not connected at all. Conceptually, it is thus provided that a slave unit then executes a command if the two following conditions are met for this slave unit: (1) there is no signal applied at the control input (DCI-in), and (2) the address is in agreement with the address used with the command by the master unit.

Bus commands are then sent to the subscriber with address 1, which assign a new address, for example, address 2, to this subscriber, wherein any other address of the address space is also conceivable. Since, at this time, only the first slave unit of the chain of slave units has no signal at the input, only this first slave unit reacts to these commands. Subsequently, a command to deactivate the signal at its output is sent to this new address 2. Thereby, the first two slave units then no longer have a signal at their DCI-in, but the third, fourth, etc., continue to have a signal.

This process (sending of readdressing commands to address 1, etc.) is continued until no further confirmation of the request for changing the address is returned. Since the slave unit address 1 is not a broadcast address, commands which are sent to this address are confirmed by the slave unit by a response telegram. Optionally, the slave units can have a signal LED. This signal LED then lights up as long as a signal is applied at the DCI-in or said DCI-in is connected to ground (which, in the terminology of the present disclosure, is considered to be a signaled input). Thereby, it is also possible to detect on the slave units how far the addressing has already progressed, and incorrect connections of DC I-out to the next DCI-in can be detected. It is only in the first slave unit in the chain that this LED does not light up, since this slave unit does not receive a DCI-in signal or it has no signaled input.

In other words, the method can be outlined as follows:

a) Optional assignment of the slave unit address 1 or of another arbitrary start address to all the subscribers by corresponding broadcast commands, so that all the slave units receive the same address.

b) Then, a broadcast command occurs or successive broadcast commands occur to all the subscribers to activate the output signal of the DC I-out at the respective output of the slave unit.

c) Subsequently, the sending of readdressing commands to the common start address occurs, with the goal of changing the address of the slave unit which has no signal applied at its DCI-in input (or which does not have a signaled state) but still has the start address. The respective changed address can be freely determined by the master unit in the address space.

d) Then, successively, the sending of a command to the respective newly allocated slave unit address to “deactivate” the DCI-out signal occurs. As soon as this has occurred, in the next successively following slave unit of the chain, a signal is no longer applied at its input DCI-in.

e) successive repeating of steps c) and d) until acknowledgment of the command for the address change of the slave unit with the originally allocated initial address no longer occurs. Here, it should be taken into account that telegrams which are not sent as broadcast, in the case of absence of reception of an acknowledgment by the master unit, are repeated multiple times, that is to say sent multiple times.

f) Optionally, the DCI-out of the last slave unit in the bus chain can be connected to an input of the master unit, and the addressing process can then be interrupted if a signal is no longer applied there and thus the last slave unit of the chain has deactivated the output signal at the output DCI-out.

The features disclosed above can be combined as desired if technically possible and if they are not mutually contradictory.

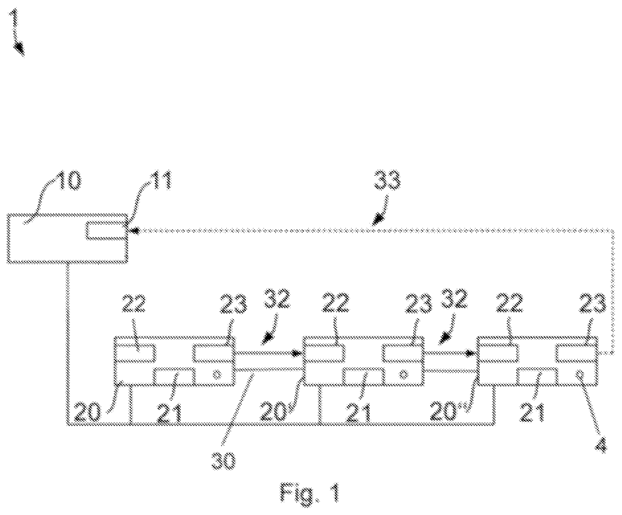

The master-slave bus system of the present disclosure is now described as an example in further detail together with reference to the FIG. 1.

The slave units 20, 20′, 20″ of the master-slave bus system 1 represented in FIG. 1 each have a control input 22 (also referred to as DCI-in) as well as a (also referred to as DCI-out). The control output 23 of the first unit 20 is connected via a control line 32 to the control input 22 of the second unit 20′, and the control output 23 of the second unit 20′ is connected to the control input 22 of the third and here last unit 20″, in each case via a control line 32 located in between. If additional slave units are used in the chain, then the previously described concept is successively further designed in this way.

The control output 23 of the last unit 20″ can optionally be connected via a control line 33, represented with a dashed line, which can also be referred to as feedback line, to a control input 11 of the master unit 10, in order to notify the master unit 10 of the end of the addressing process, which is implemented by the transmission of a signal from the last unit 20″ to the master unit 10, namely when the control output 23 has been put in the non-signaled state by command of the master to the last slave unit.

Furthermore, each of the units 20, 20′, 20″ has a higher-level control logic 21 implemented by a microcontroller, which is designed to use or process input-side signals processed by the input circuit and to control the output circuit for generating the output-side signal. Since the units 20, 20′, 20″ are provided as slave units of a master-slave bus system 1, they are also referred to as slave units below.

At the beginning of the method according to the invention, a predetermined start address is assigned to all the slave units 20, 20′, 20″ (for example, the address 1).

A message transmitted by the master unit 10 to the start address is then received or processed by all the slave units 20, 20′, 20″ but does not lead to a reply of the slave units 20, 20′, 20″ (which is the case when the message has been sent to the broadcast address 0).

For the correct operation of the master-slave bus system 1, each slave unit 20, 20′, 20″ must have a unique unit address within the bus system, so that a communication request by the master unit 10 or a message transmitted by the master unit 10 via the bus line 30 is processed and answered by only one slave unit 20, 20′, 20″ and in particular by the slave unit which, due to an address change request, changes its output to the non-signaled state, so that at the input of the next (following) slave unit an input signal is no longer present. However, this is the condition for the processing of the address change request by the addressed slave unit. Since, at the beginning of the method, only the first slave unit has no signaled input, this slave unit also only changes its addressing in accordance with the command from the master unit.

The sending of a command, to the new address changed by the master unit 10 with the address change request, to the slave unit which has just received this new address then occurs. The command comprises the “deactivation” of the DCI-out signal of this slave unit. As soon as this has occurred, in the next successively following slave unit of the chain, a signal is no longer applied to its input DCI-in.

This process is successively repeated until acknowledgment of the command of the master unit 10 for the address change of the slave unit with the originally allocated initial address no longer occurs. Optionally, the acknowledgment can be displayed in an optically visible way by means of an LED 4 on each slave unit 20, 20′, 20″.

Moreover, optionally, a termination of the method can occur when the master unit 10 has sent the address change command to the last slave unit and said last slave unit sends the termination condition to the master unit 10 via the optional control line 33.

When all the slave units 20, 20′, 20″ have thus been assigned an address, that is to say when one of the conditions for terminating the method has been met, the slave units 20, 20′, 20″ can be switched from the addressing mode to their operating mode, which can be initiated by means of a message of the master unit 10 to the newly allocated addresses.

The present disclosure is not limited with regard to its embodiment to the aforementioned preferred embodiment examples. Instead, a number of variants are conceivable, which use the represented solution also in embodiments of fundamentally different type. All the disclosed features can be used in any combinations desired if technically possible. Thus, it will be appreciated that the invention is susceptible to modification, variation and change without departing from the proper scope and fair meaning of the accompanying claims.

1. A master-slave system comprising a master unit with n slave units which are serially connected via a bus line, each slave unit having a control input for receiving an input-side signal from the output of the preceding slave unit in the series and a control output for sending an output-side signal to the respective following slave unit in the series of the n slave units;
wherein the control input of the first slave unit is not signaled; each slave unit having an address memory, which is designed to store a collective broadcast address and/or an individual unit address;
wherein, a control line is provided between two serially successive slave units, which respectively connects the control output of the preceding slave unit in the series to the control input of the following slave unit, in such a manner that the output signal at the control output is at the same time the input signal at the control input of the respective following slave unit.

2. The master-slave system according to claim 1, characterized in that the input circuit and the output circuit as well as the control input and the control output are separated from one another with regard to their circuitry and/or connected to one another by only a higher-level control logic of the respective unit.

3. The master-slave system according to claim 1, characterized in that each slave unit has an internal microcontroller.

4. The master-slave system according to claim 2, characterized in that each slave unit has an internal microcontroller.

5. The master-slave system according to claim 1, characterized in that the master unit is designed to send an address change command to one or more slave units, but only the slave unit, the control input of which is not signaled and which has the address addressed by the master unit, executes the address change command.

6. The master-slave system according to claim 2, characterized in that the master unit is designed to send an address change command to one or more slave units, but only the slave unit, the control input of which is not signaled and which has the address addressed by the master unit, executes the address change command.

7. The master-slave system according to claim 3, characterized in that the master unit is designed to send an address change command to one or more slave units, but only the slave unit, the control input of which is not signaled and which has the address addressed by the master unit, executes the address change command.

8. The master-slave system according to claim 4, characterized in that the master unit is designed to send an address change command to one or more slave units, but only the slave unit, the control input of which is not signaled and which has the address addressed by the master unit, executes the address change command.

9. The master-slave system according to claim 5, characterized in that the master is designed to send such a command to a slave unit with a certain address so as to transfer its control output into a non-signaled state which preferably also directly determines the state at the following control input.

10. The master-slave system according to claim 6, characterized in that the master is designed to send such a command to a slave unit with a certain address so as to transfer its control output into a non-signaled state which preferably also directly determines the state at the following control input.

11. The master-slave system according to claim 7, characterized in that the master is designed to send such a command to a slave unit with a certain address so as to transfer its control output into a non-signaled state which preferably also directly determines the state at the following control input.

12. The master-slave system according to claim 8, characterized in that the master is designed to send such a command to a slave unit with a certain address so as to transfer its control output into a non-signaled state which preferably also directly determines the state at the following control input.

13. A method for addressing n slave units of a master-slave system according to claim 1, the method comprising the following steps:
a) setting of a common start address at all the n slave units, preferably by broadcast command(s) or by factory setting, so that all the slave units have the same start address;
b) successive sending of broadcast commands from the master unit to all the slave units to activate the output signal of the control output at the respective control output of the slave unit in question;
c) sending of readdressing commands to the slave units with common start address with the goal of changing the address of the respective slave unit which has no signal applied at its control input or which has no signaled state;
d) sending of a command to the respective newly allocated slave unit address to “deactivate” the signal at the control output at the slave unit in question, so that, in the next successively following slave unit in the chain, a signal is no longer applied at its control input.
e) successive repeating of steps c) and d) until all the slave units are readdressed and, in particular, until acknowledgment of the command for the address change of the slave units with the originally allocated initial address no longer occurs.

14. The method according to claim 6, wherein the control output of the last slave unit in the chain of slave units is connected via a control line to an input of the master unit, and the addressing process is then interrupted if a signal is no longer applied at the control output of the last slave unit and thus the last slave unit of the chain has deactivated the output signal at the control output due to an instruction according to step d).

15. A method for addressing n slave units of a master-slave system according to claim 12, the method comprising the following steps:
a) setting of a common start address at all the n slave units, preferably by broadcast command(s) or by factory setting, so that all the slave units have the same start address;
b) successive sending of broadcast commands from the master unit to all the slave units to activate the output signal of the control output at the respective control output of the slave unit in question;
c) sending of readdressing commands to the slave units with common start address with the goal of changing the address of the respective slave unit which has no signal applied at its control input or which has no signaled state;
d) sending of a command to the respective newly allocated slave unit address to “deactivate” the signal at the control output at the slave unit in question, so that, in the next successively following slave unit in the chain, a signal is no longer applied at its control input.
e) successive repeating of steps c) and d) until all the slave units are readdressed and, in particular, until acknowledgment of the command for the address change of the slave units with the originally allocated initial address no longer occurs.

16. The method according to claim 15, wherein the control output of the last slave unit in the chain of slave units is connected via a control line to an input of the master unit, and the addressing process is then interrupted if a signal is no longer applied at the control output of the last slave unit and thus the last slave unit of the chain has deactivated the output signal at the control output due to an instruction according to step d).
